(19) United States
(12) Patent Application Publication
(10) Pub. No.: US 2010/0321399 A1
(43) Pub. Date: Dec. 23, 2010

(54) Maps from Sparse Geospatial Data Tiles

(76) Inventors: Patrik Ellren, Goteborg (SE); Anders Gustafsson, Goteborg (SE)

Correspondence Address: POTOMAC PATENT GROUP PLLC, P. O. BOX 270, FREDERICKSBURG, VA, 22404, US

(21) Appl. No.: 12/487,466

(22) Filed: Jun. 18, 2009

(51) Int. Cl. G09G 5/00; G06T 1/00

(52) U.S. Cl. 345/587; 345/522

(57) ABSTRACT

Existing map solutions using tiled maps with geographic data in vector format typically has such a volume of data that not all geographic data can be stored in memory. A primary bottleneck for map rendering speed in such solutions is the time needed to load all data necessary for replacing one rendered map with the next rendered map. Utilizing the structure and methods of the invention herein when loading geographic vector data, the average time to load all necessary geographic data needed for one rendered map to the next will be greatly reduced—the loading time reduction will be especially large when pan and zoom operations are the main transitions from one rendered map to the next.

### BACKGROUND

The present invention relates generally to computer-based map systems and methods, and more particularly to map systems and methods that use geographic data stored in a local or remote memory.

In a typical computer-based map system, all or parts of a set of geographic information is retrieved by a map-generating module in tiles where some or all of the data is in vector format. In such systems, the amount of available geographic data is typically large, so large that not all data of a used map can be fitted at the same time into the random-access memory (RAM) of the map generating module. As a result, the data is loaded into the RAM in parts over time, typically from local storages or via network connections from remote storages.

Many tile-based map clients handle maps in tiles organized in a tree, such as that depicted for example in FIG. 2, which shows a tree having three scale levels, one level of 1:32000 (200), a second level of 1:16000 (210), and a third level of 1:8000 (220). When loading and displaying a new map tile in the client, four steps are performed:
1. transfer map data for the tile from one or many storages to internal memory;
2. parse the data from transfer format to internal format;
3. rescale data to fit current local scale; and
4. visualize the rescaled data on the screen.

Geospatial data is characteristically very voluminous and thus viewing maps covering more than just small local areas demands a lot of input/output (I/O) or bandwidth and processing time. A mobile device, for example, has a number of limitations such as limited processor speed and local I/O speed as well as limited bandwidth that need consideration when developing map-based applications.

Furthermore, if map data is stored on a server in a network with limited network speed, the transmission delays will add even more time to step 1 above.

In many existing solutions, the tile tree has a relatively large number of scale levels, many more than the number of real and unique levels available in the original source map data. The current standard solution is to prepare data for all tile-tree layers such as those depicted in FIG. 2 with a process that is depicted by FIG. 5 and let a storage handler, locally or remotely, deliver data for all tile-tree layers on demand. This approach is used in numerous solutions, of which one of the most well known is Google Maps, by Google Inc., Mountain View, Calif., USA.

As depicted in FIG. 5, a request for map data is received (step 502) and it is determined (step 504) whether all map scales have been built. If so (Yes in step 504), the process is complete (step 506), but if not (No in step 504), a next scale is chosen (step 508) and map data tiles for that chosen scale are built. If tiles for the entire requested area have been built (Yes in step 510), the flow returns to step 504 to determine whether tiles at more scales remain to be built. Otherwise (No in step 510), a next tile is chosen (step 512) and the chosen tile is exported for the storage handler (step 514), after which the flow returns to step 510 to determine whether more tiles at the chosen scale remain to be chosen. Eventually, a tile-tree comprising tiles covering the requested area at all scale levels is developed.

A problem with such a solution is that the same source data may be loaded and processed multiple times at different levels in the tile-tree, for example, while zooming in and out, thereby wasting valuable processing resources and possibly transmission bandwidth, and reducing the overall performance. If the user of the map application zooms the map from one scale level to another, the map client will start requesting new tiles at the new scale level and throw the old tiles away. The new tiles may contain the same source data, but possibly differ in detail level due to rasterization, and so the new tiles may actually read and process the same source data as the old tiles.

As described above, the standard way of supplying the map tile-tree with data is to have a new data set available for each scale in the tile-tree. The most common approach in tiled map solutions is to use raster images covering the map. Each tile in every tile level will be loaded with data in the form of a complete map tile picture. This approach is described in U.S. Pat. No. 7,158,878 for “Digital Mapping System” by J. Rasmussen et al. and used in Terra Service.NET by Microsoft Inc., Redmond, Wash., USA.

Another approach is to use the same loading algorithm as above but with data stored as vector tiles instead of raster tiles. This may reduce network load if a map data tile in vector format is smaller, counted in bytes, than a raster tile. This approach will still consume I/O and processing resources since each tile in all tile-tree levels has to be filled with data, and for very detailed data, the overhead of storing data in vector format will eliminate the gains won by not transmitting the preprocessed raster tiles. This approach is used in Virtual Earth by Microsoft Labs, Redmond, Wash., USA.

The vector map tiles can be even further elaborated by preprocessing the data and storing it in differential steps, one for each layer in the client. Base data is stored on coarser levels, and only the additional data needed to build finer steps is stored. A map is then built by first loading the coarsest level, which will be without fine details and so be quick to load and display, then stepping through finer scales and loading the additional, differential data for each scale, thus successively completing the image until all levels have been loaded and the map is complete. This makes the map appear progressively more detailed to the user. This approach is described in, for example, U.S. Pat. No. 7,269,510 for “Device and Carrier of Map Information Data” by J. Persson. Even though each tile may be shown quicker to the user in coarser detail, this patent describes a non-tiled map solution that needs more local processing since each tile has to be reassembled locally from data on all levels loaded.

On top of all the approaches described above comes caching, i.e., reusing already loaded map tiles when requesting tiles for exactly the same geographic center and scale. This is a purely mechanical caching and can be added to the approaches described above on many levels, for example:
in a memory-based client cache when accessing data from local storage;
a local-storage cache when requesting data over network, e.g., a web browser cache;
network-based caches, e.g., store and proxy solutions in gateways and firewalls;
pre-fetched local storage data together with additional server data, e.g., in a navigator with some preinstalled data; and/or
server-based caches reducing data lookup and disk-read operations, e.g., web-based caching mechanisms as squid.

Prior caching descriptions also include tiling of three-dimensional (3D) computer-aided design (CAD) data enclosed in level of details (LODs), where the separate LODs then are split into CAD tiles. These CAD tiles can then be cached to decrease transmission time when requested from a remote server, as described in, e.g., U.S. Pat. No. 7,283,135 for “Hierarchical Tile-Based Data Structure for Efficient Client-Server Publishing of Data over Network Connections” by S. Cote et al.

These caches will work well with the tile-based approach described above but only when data already fetched is needed again, typically when data for the same geographic location AND in the same scale is requested a second time.

There is thus still a need for a solution that addresses many of the problems and shortcomings that beset the technologies described above.

### SUMMARY

Existing map solutions using tiled maps with geographic data in vector format typically has such a volume of data that not all geographic data can be stored in memory. A primary bottleneck for map rendering speed in such solutions is the time needed to load all data necessary for replacing one rendered map with the next rendered map.

Our invention uses tiles of stored geographic data available at some scales to generate maps having several scales, including but not limited to the scales of the stored data. The geospatial data is organized in a tile-tree in which different tiles contain approximately the same amount of data. This is accomplished by a data generation process that packs details higher in the tree for areas where the data density is low.

In an aspect of this invention, there is provided a method of organizing computer-based map data corresponding to an area. The method includes generating a tile-tree having a plurality of levels of tiles of the map data, and packing tiles of the tile-tree based on a density of map data to reduce a number of tiles in the tile-tree. Tiles of different levels include map data of different respective scales, and tiles include respective unique identifiers.

In another aspect, there is provided an apparatus for organizing computer-based map data corresponding to an area. The apparatus includes a tile-tree generator and a tile packer. The tile-tree generator is configured to generate a tile-tree having a plurality of levels of tiles of the map data, in which tiles of different levels include map data of different respective scales, different tiles include approximately the same amount of map data, and tiles include respective unique identifiers. The tile packer is configured to pack tiles of levels of the tile-tree based on a density of map data in the tiles of levels. The tile-tree generator is configured to generate the tile-tree by determining a first set of tiles of map data that cover the area at a largest scale, the first set of tiles being included in a first level of the tile-tree, and by determining successive sets of tiles included in successive levels of the tile-tree from the first set of tiles.

In another aspect, there is provided a computer-readable medium having stored therein instructions that, when executed by a computer, cause the computer to carry out a method of organizing computer-based map data corresponding to an area. The method includes generating a tile-tree having a plurality of levels of tiles of the map data, and packing tiles of levels of the tile-tree based on a density of map data in the tiles of levels. Tiles of different levels include map data of different respective scales, different tiles include approximately the same amount of map data, and tiles include respective unique identifiers. Generating the tile-tree includes determining a first set of tiles of map data that cover the area at a largest scale, the first set of tiles being included in a first level of the tile-tree, and determining successive sets of tiles included in successive levels of the tile-tree from the first set of tiles.

By minimizing the number of tiles and average amount of data transferred, from local or remote storage, the total data transfer and processing time can be reduced. Utilizing the structures and methods of this invention when loading geographic vector data, the average time to load geographic data needed for one rendered map to the next will be greatly reduced. The loading time reduction will be especially large when pan and zoom operations are the main transitions from one rendered map to another.

### BRIEF DESCRIPTION OF THE DRAWINGS

The objects, features, and advantages of the invention will be understood by reading this description in conjunction with the drawings, in which:

FIG. 1 is a block diagram of an exemplary apparatus for carrying out methods in accordance with the present invention that combines data stored locally in the apparatus with remotely stored data;

FIG. 2 depicts a tile-tree having three scale levels, showing how geographic data is organized into tiles per scale level and how each tile has a single parent and four sibling tiles;

FIG. 3 depicts how the data in a standard application is stored with a lower detail level in tiles that are “more zoomed out”;

FIG. 4 depicts how the data in the present invention can be packed with a higher detail level in tiles that are “more zoomed out”;

FIG. 5 depicts how a tile-tree with geographic data is traditionally built;

FIGS. 6A and 6B depict how a tile-tree with geographic data is built in the present invention and how details are packed higher in the tree when data density is low in the present invention;

FIG. 7 depicts how the present invention loads and combines locally stored data with data downloaded from remote storage;

FIG. 8 depicts how a server handles tile requests from an embodiment of the present invention;

FIG. 9 depicts how the present invention combines different data sources into a single image, grayed tiles contain data while white tiles do not contain any data;

FIG. 10 depicts how a tile-tree is organized into tiles at different scale levels;

FIG. 11 depicts how levels can be missing in the data;

FIG. 12 depicts how individual tiles can be missing in the data in the present invention;

FIG. 13 depicts how a complete map image at scale layer 1 is created from several tiles at different scale layers, a solid outlined rectangle (on layer 1) represents the level and area used for the map image rendered, while the dotted outlined rectangles show the same area on levels higher up in the tile-tree from where data will be loaded if missing on lower levels;

FIG. 14 depicts a zoom operation that only requires one more tile to be loaded;

FIG. 15 depicts a pan operation that does not require any more tiles to be loaded; and

FIG. 16 depicts how an embodiment of the invention looks for a single tile.

### DETAILED DESCRIPTION

The present invention provides methods and apparatus for reducing the overall amount of data needed to be transmitted over time and the number of communication connections necessary, thus reducing overall time for loading necessary data from local and/or remote storage for map rendering.

Our invention handles geospatial data that is preferably organized in a tile-tree, which has the following characteristics.
The tile size, in screen pixels, is selected to make each resulting map image have more than one tile but not too many. Having a large tile size, maybe even bigger than the screen, would increase the amount of loaded data, since some parts of the tiles needed to cover the area visible on the screen will also cover areas outside the screen. Having too many tiles for a map would increase tile management overheads and reduce performance. Typically, five to ten tiles are suitable to cover the relatively small screen of a mobile device.
The difference in scale for two consecutive levels in the tile-tree is selected so that it is not too small, which would lead to many scale levels and possibly many map tile requests, or too large, which would also increase the amount of data loaded for areas outside the screen. The ratio between the scales of two consecutive levels can be set to 1:2, and each scale level has four times as many tiles as the next coarser level, see FIG. 10.
The tiling can be done in such a way that all or most clients will request map tiles from the same set of tiles; using the same set of tile centers, tiles sizes and map scales, makes caching of tiles possible on the server side.
Every tile in the tree has a unique identifier.
A tile identity can be converted from and to the geographic area covered by the tile and a scale through simple mathematical operations.
Given a tile identity, it is possible to quickly calculate the identity of the parent tile or of any of the child tiles, which also means that the identities of all sibling tiles can be calculated quickly.

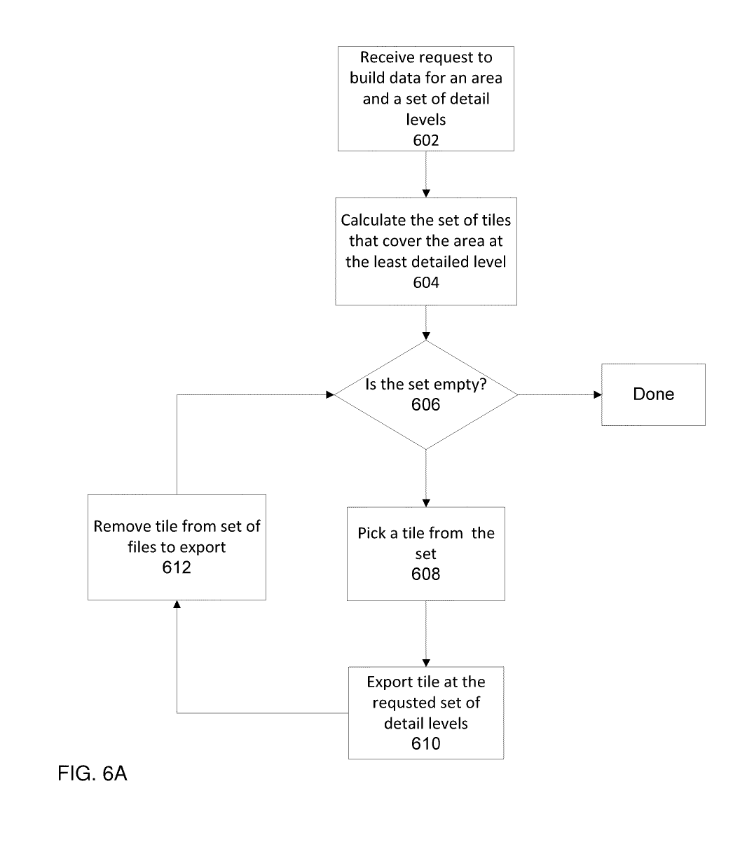

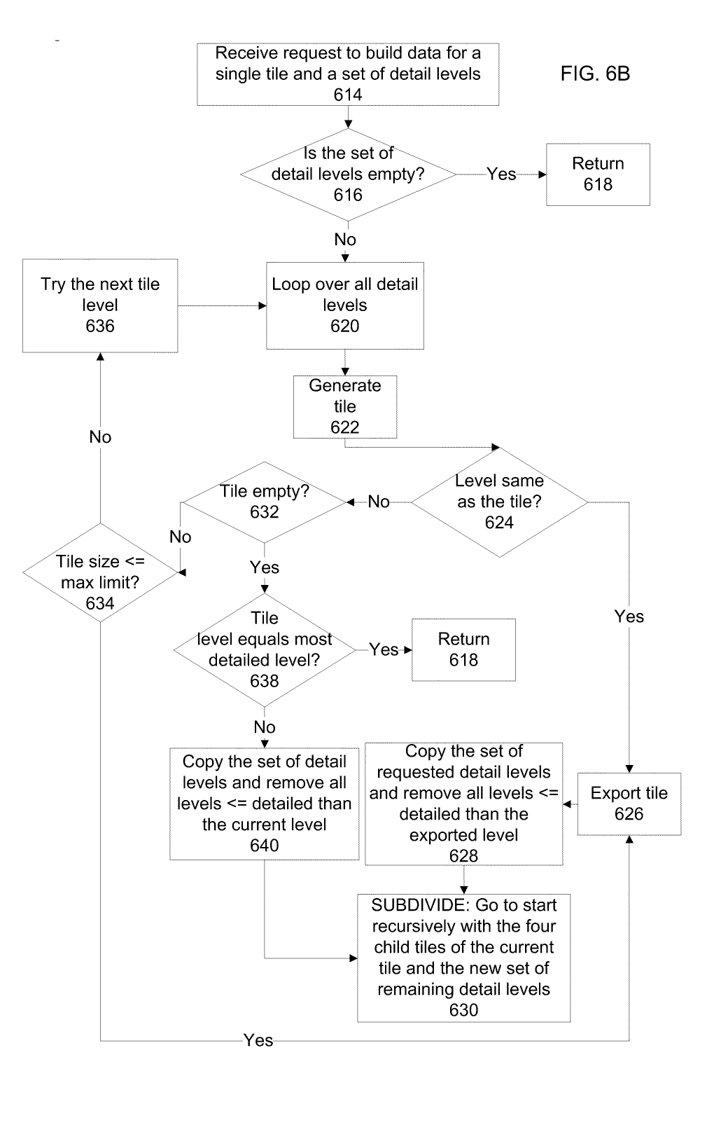

Given these characteristics, the tile-tree can be filled with data by a top-down, bottom-up or heuristic process. FIGS. 6A and 6B depicts how the tile-tree is filled with data using a recursive top-down process. The inputs to the data generation process comprise:
source vector data, e.g., data acquired from Navteq, Teleatlas, or OpenStreetMap;
the area to generate data for (which is typically a country, a continent, or the entire world) and a coordinate reference system suitable for the area;
a description of how the vector data is generalized at different scale levels;
a list of the detail levels to include in the generated data; and
a maximum tile size that is used to determine when a tile must be split into separate child tiles.

The outputs of the data generation process comprise a set of tiles and a description of the tile-tree levels for which a particular feature set can be displayed. The description can be used by a client to display only a particular feature set, e.g., small roads, when the view is sufficiently zoomed so that the feature set is guaranteed to be present in the tiles.

The vector source data is typically available in only a very detailed form, and the data generation process generalizes it at several detail levels. Cartographic generalization is the process of selecting data that is displayed at a specific scale. The simplest form of generalization is simply to remove entire features at low levels of detail. For example, when zooming out to look at an entire country, features like buildings and small roads can be removed. In addition to the simplest form of generalization that removes entire features, the data generation process uses conventional line- and polygon-thinning algorithms to remove details that are on the edge of visibility from individual features. Suitable algorithms include the Douglas-Peucker algorithm described in, for example, U.S. Pat. No. 7,430,340 for “Geographic Information Data Base Engine” to P. Glass et al. and the Visvalingham-Whyatt algorithm that is described in the literature, such as M. Visvalingham and J. D. Whyatt, “Line Generalization by Repeated Elimination of Points”, The Cartographic Journal, Vol. 30, pp. 46-51 (1993).

In addition to the generalization and required detail levels in the output, a maximum size limit for an individual tile is specified. The maximum size limit determines when a tile contains too much data and must be split. One way to arrive at a suitable maximum size limit is to generate data for the most detailed level that is required over an area where the data density is high, and then pick the average tile size as the maximum size limit. For example, generate a set of tiles that contains the street data for a city, and pick the average tile size as a maximum size limit.

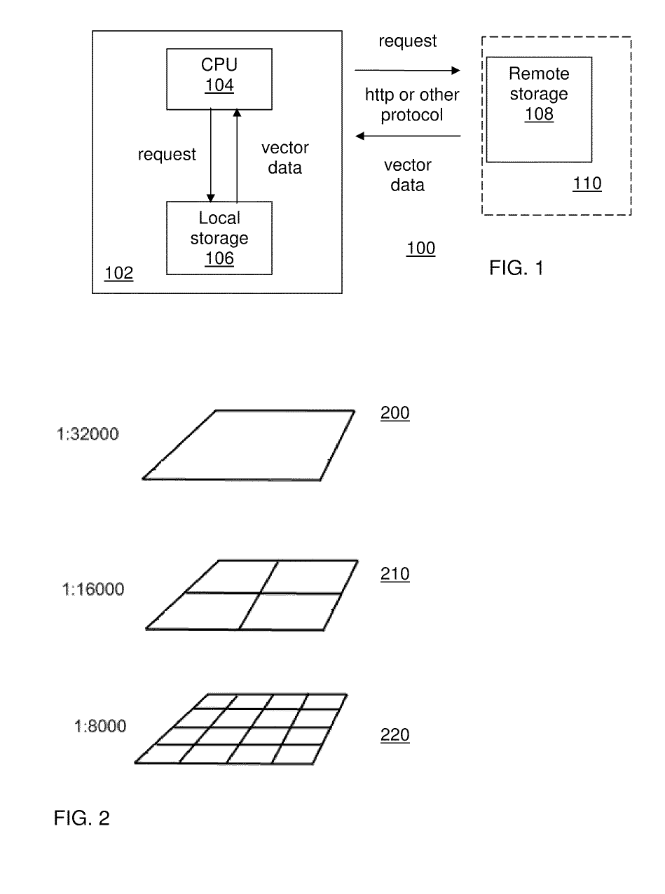

Data generation processes according to the present invention can be implemented by an apparatus 100 such as that depicted by FIG. 1. The apparatus 100 includes a client device 102, such as a portable computer, which has a processor 104 and a local memory 106 that exchange requests and vector data as described in this application. As depicted in FIG. 1, the client device 102 communicates with a remote memory 108, exchanging requests and vector data according to any suitable protocol, such as the hypertext transfer protocol (http). It will be appreciated that the remote memory 108 can be part of a server device 110, and the arrangement of functionalities depicted in FIG. 1 is just an example, and other equivalent arrangements are possible. In general, the functions and methods describes in this application can be performed by one or more suitably programmed digital signal processors, such as the processor 104 and/or a suitable processor or processors in the server device 110. Such a programmed processor or processors can be considered a tile generator and a tile packer as described in detail in this application.

The data generation process then proceeds according to the top-down approach depicted in FIGS. 6A and 6B until data for the whole area and all required detail levels have been exported. The description of the tile-tree levels for which a particular feature set can be displayed is generated from the list of detail levels that was given as an input to the process.

As depicted in FIG. 6A, a request is received (step 602) for map data for a specified area with a set of scale levels. In step 604, the set of tiles that covers the specified area at the least detailed scale level is determined. In step 606, it is determined whether the set of tiles is empty, which is to say, that all tiles have been exported. If so (Yes in step 606), the process is complete, but if not (No in step 606), a tile is picked from the set (step 608) and the picked tile is exported (step 610) at the requested set of detail levels. The export process carried out in step 610 is depicted by FIG. 6B, which is described in more detail below. Upon returning from the process depicted in FIG. 6B, the chosen tile is removed from the set of tiles to export (step 612), after which the flow returns to step 606 to determine whether the set of tiles is empty.

Upon the export process described above a request to build data for a single tile and a set of detail levels is received as depicted in FIG. 6B (step 614). If the set of details is empty (YES in step 616) the process returns accordingly to its stack trace status (step 618). If the set of details is not empty (NO in step 616), all detail levels are looped all over in order from the most detailed to the least (step 620).

For each iteration a tile is generated (step 622) and a comparison is made to decide whether the newly generated tile has the same level as the entry point tile (step 624). If so (YES in step 624), the tile is exported (step 626) after which the set of requested detail levels is copied and all levels equal to or less detailed than the exported level are removed (step 628). This process is recursively repeated from the entry point of the flowchart (step 614) with the four child tiles of the current tile and the new set of remaining detail levels (step 630).

If the result of step 624 is NO, there is to be decided if the newly generated tile is empty (step 632). If not (NO in step 632), and the tile size is not less or equal to the max limit (NO in step 634), the iteration (step 620) starts over, and if it is less than or equal to the max limit (YES in step 634), the process continues to the earlier described tile export (step 626). If the tile according to step 632 is empty (YES in step 632) and the tile equals the most detailed level (YES in step 638), the process returns in the same manner as described in step 618 above; else (NO in step 638) the set of detail levels are copied and all levels equal to or less detailed than the current level are removed (step 640). Also this process path starts over recursively as described in step 630 above.

The process depicted in FIG. 6B is recursive, so any return point (step 618) will either continue processing tiles or return to the export step described in step 612 in FIG. 6A.

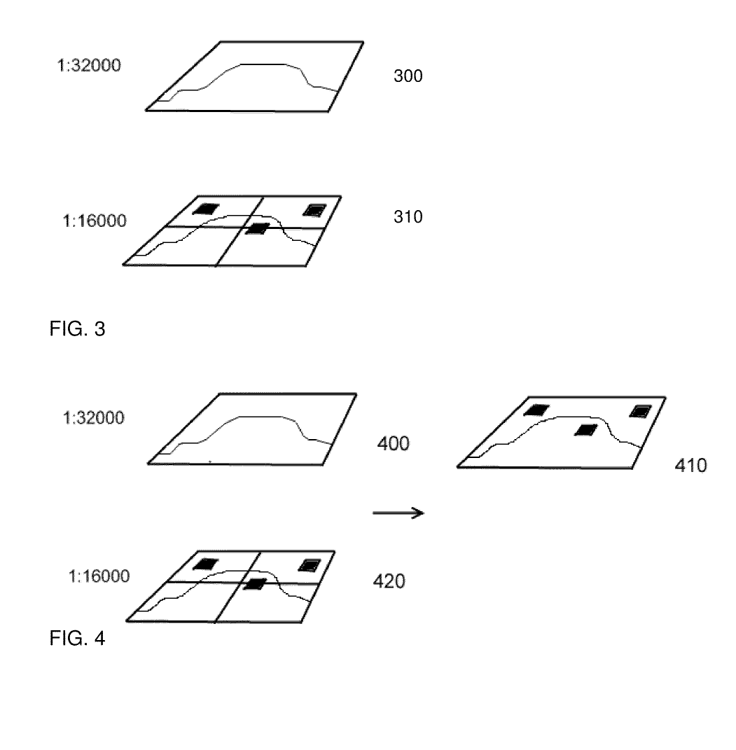

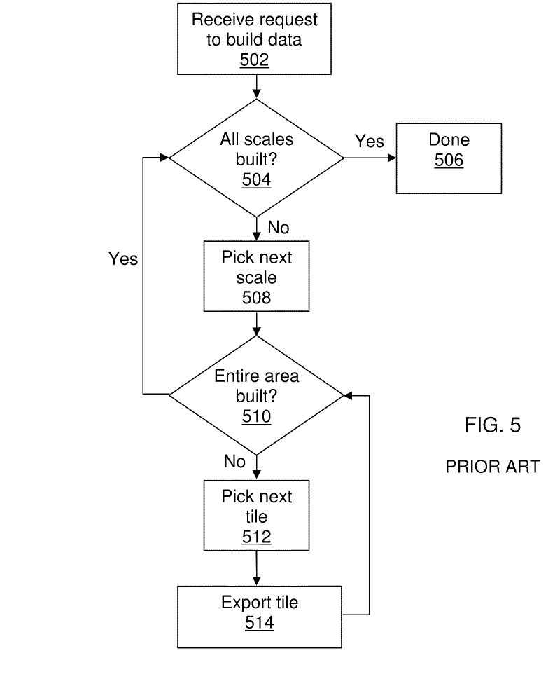

The organization of the data in the tile-tree used by the invention allows the invention to load fewer new tiles, when the main operations are pan and zoom, than a traditional solution. This is accomplished by taking advantage of the fact that many tiles contain data that is more detailed than would be the corresponding tile in a traditionally organized tile-tree like. FIG. 3 depicts an approach according to prior art. A more detailed level (310) contains more data than a higher level (300). FIG. 4 depicts how the data is contained in a tile at a higher zoom-level (410) in the present invention compared to the approach according to prior art (400 and 420). The invention detects when this occurs and reuses the already loaded data.

Very often, the case will be that the number of levels in the tile-tree far outweighs the number of different data levels available. For example, a tile-tree having 24 levels, with a ratio 1:2 between tile-tree tile width sizes, has scales from 1:1000 up to just short of 1:1000000000. Typically, a map application would have unique map data available in only a handful of those 24 levels.

So it will be unnecessary to supply all tile-tree levels with their own map data, i.e., creating and delivering a separate dataset scale level for each map tile level is not needed. This would create an unnecessary volume of map data since often the same map data will be delivered for several different scale levels.

Using our invention, only those tile levels having new map data are supplied with data.

In our invention, each tile will have its unique identity algorithmically calculated. The method for doing this calculation is preferably the same on both the client and the server with the same setup of scale levels and geographic extension for the area maps to be created in.

Since the same tile identities are understood by both the client and the server, the client needs just to ask for a map tile using its identity; neither the geographic location, extent of the tile, or its scale is needed in the request.

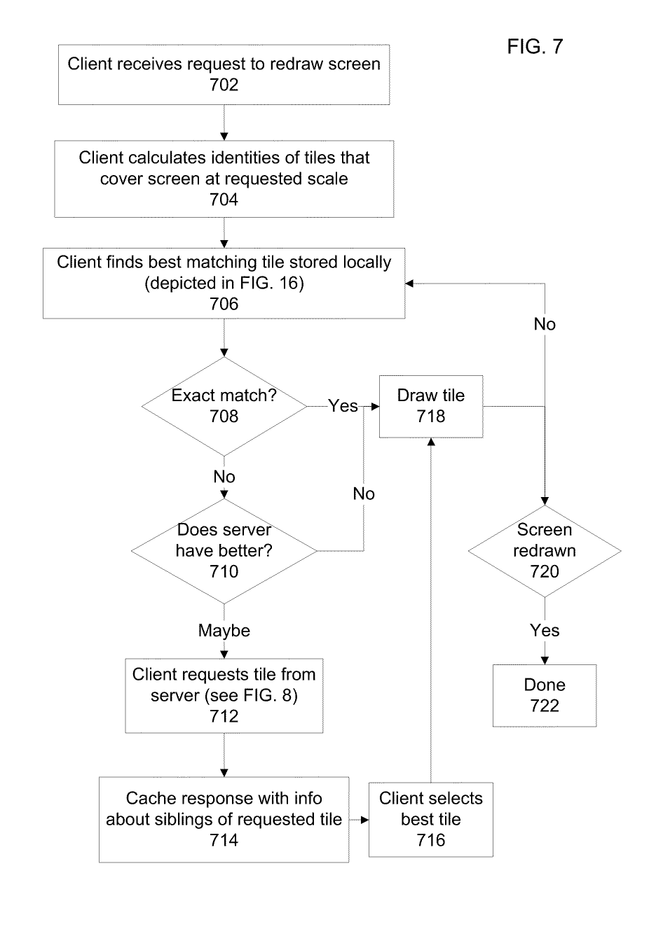

When the client needs a map tile, it will not just compute the identity of the tile, but also check if it already has a tile in a coarser scale covering the same area, using the tile-tree to do this. When the client asks the server for the tile, the client adds the information on what coarser tile, if any, it already has. This is explained in detail in FIG. 7.

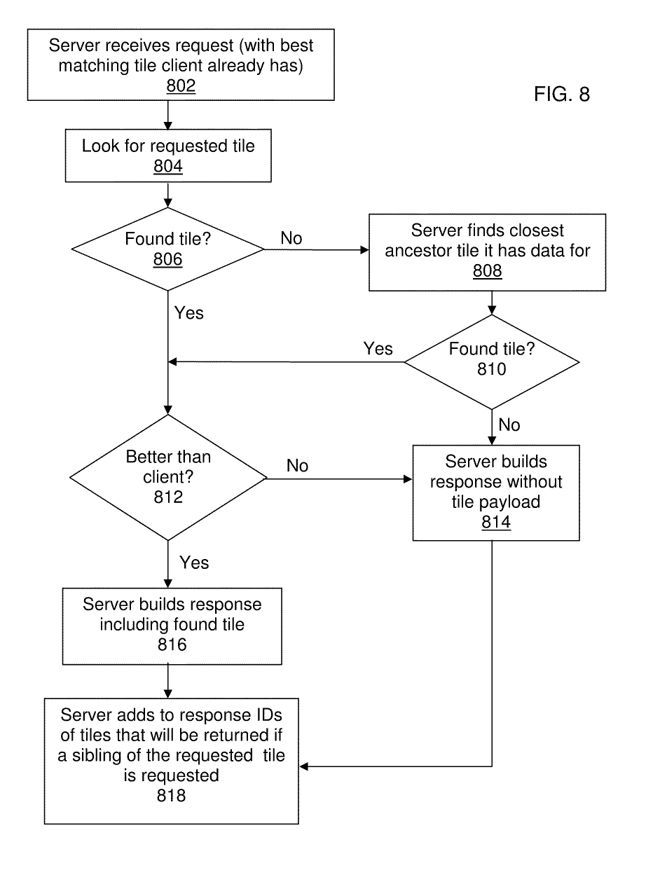

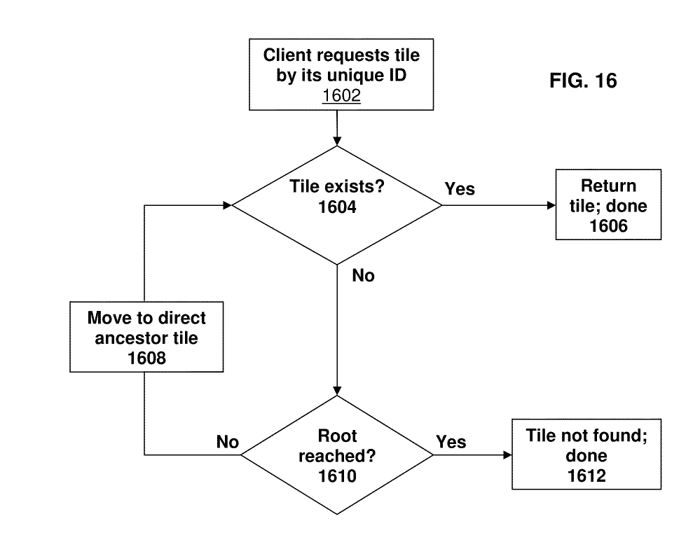

As depicted in FIG. 7, the client receives a request to redraw the screen (step 702) and calculates identities of tiles that cover screen at the requested scale (step 704), and thereafter it picks one of the calculated tile identities and finds the best matching tile stored locally (step 706). This process is further explained in FIG. 16. If no exact match is found (NO in step 708), the client checks (step 710) in its locally stored cache if the server may have a better match. This check uses information that has been returned by the server in responses to earlier requests (step 714). If the local cache does not respond NO (MAYBE in step 710), the client requests a tile from the server (step 712), which is depicted in FIG. 8. The client caches the response downloaded from remote storage (step 714), which includes information about the sibling tiles of the requested tile (depicted in FIG. 8, step 818), and combines it with locally stored data from which the best matching tile is selected (step 716). The best matching tile would have been selected prior to this step if the client had found an exact match (YES in step 708) or if the client could determine through the local cache of earlier responses that the server did not have a better match (NO in step 710). Either path leads to the drawing of the tile (step 718). If the screen is not completely redrawn (NO in step 720), the client iterates back to find the best matching locally stored tile (step 706) for the next tile needed to cover the screen; else (YES in step 720) the process is done (step 722).

In order to find a particular tile as describe in step 706 above there is a mechanism to identify it. This is depicted in FIG. 16. The client calculates the unique identity of the tile and requests it (step 1602). If it is found (YES in step 1604), it is returned (step 1606). If it is not found (NO in step 1604), the client checks if the root node has been reached (step 1610). If it has not been reached (NO in step 1610), the cursor is moved to the direct ancestor tile (step 1608). This is repeated until it has found a match and is able to return the tile (step 1606), or until it has reached the root tile (YES in step 1610) and no tile is returned (step 1612).

The server checks the dataset to see if it has data for the requested map tile, see FIG. 8 (step 804), and if so (YES in step 806) and it is better than the tile from the client (YES in step 812), the server builds a response including the found tile (step 816). If there is no data in that particular map tile (NO in step 806), the server starts moving up in the scale levels to find a map tile it has data for (step 808). When a tile is found that is better than the coarse tile the client already had, the server returns that map tile (step 816). If the server does not find a better tile than the client already has (NO in step 818), the server returns a minimal answer, telling the client to use the coarser tile it already has (step 814). The server also preferably includes information about which tiles it will return if a sibling tile of the requested tile is requested. This information is used by the client, see FIG. 7 (step 710), to decide if it needs to call the server at all when it loads neighboring tiles (step 818), which is a very common operation.

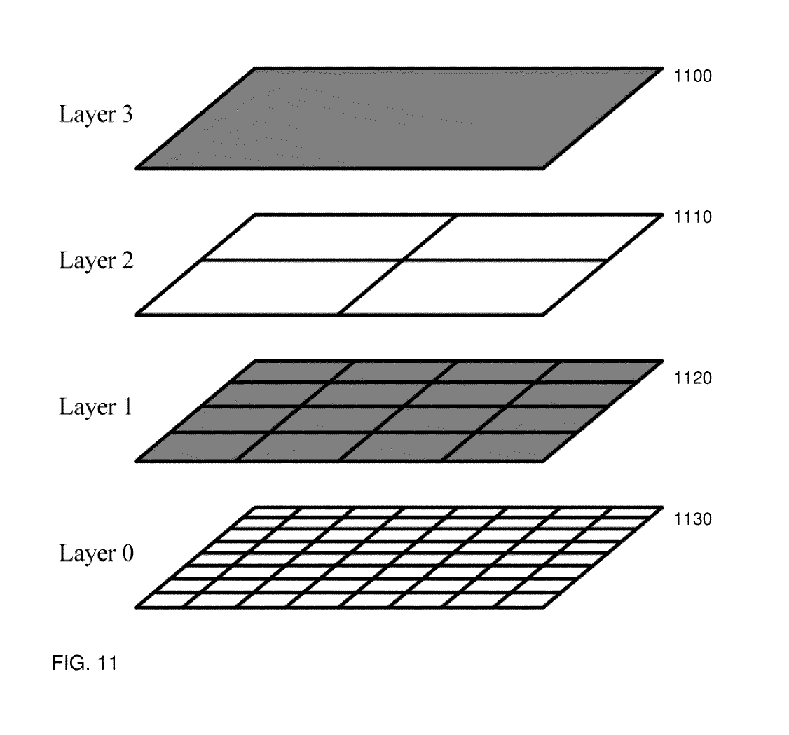

In the example in FIG. 11, when zooming from layer 3 (1100) to layer 2 (1110), no new map data is available so none is returned. The client can create the map instantly from the data it already has received for tile layer 3 (1100).

Furthermore, map data will typically not be available for an entire area. An example of this is data on finer scale levels such as city maps. Here even more gains will be possible with the invention since only a subset of tiles that belong to a level will contain any data.

The invention herein is compliant with such caching solutions described in prior art. It will be appreciated that the present invention does not need data to be pre-fetched.

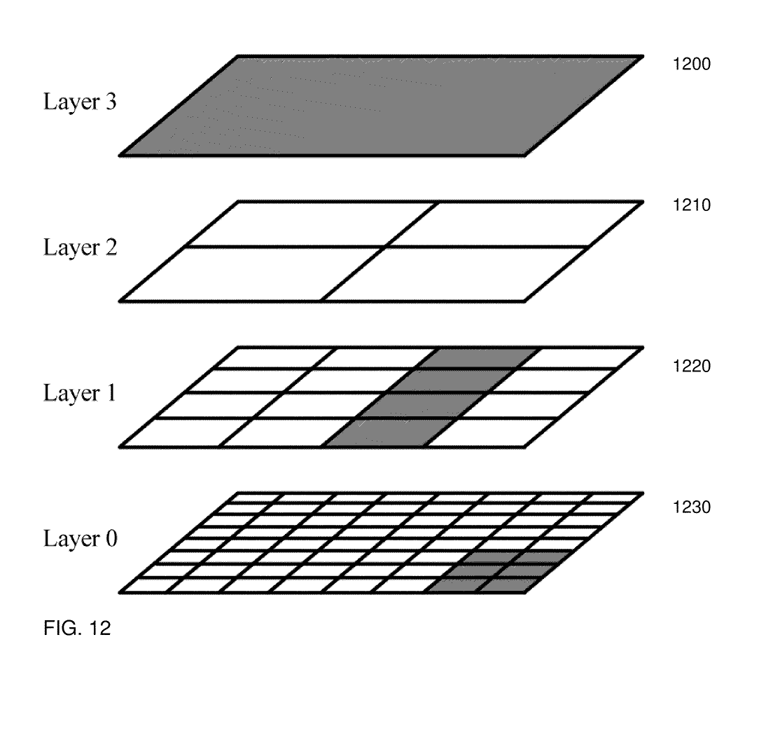

In the following more elaborate example depicted in FIG. 12, there will be map data available covering all of layer 3 (1200), and some parts of layer 1 (1220) and 0 (1230).

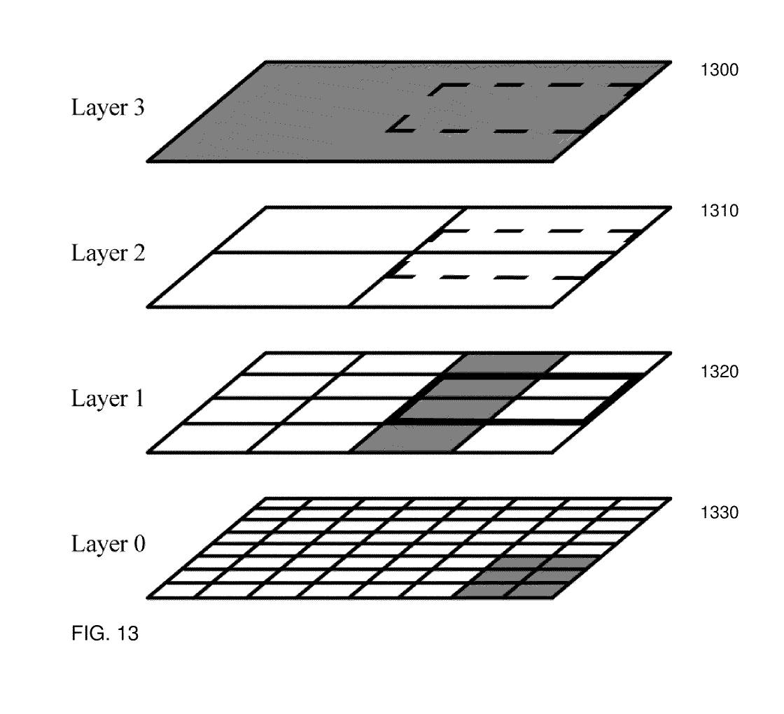

When creating a map in layer 1 (1320) in the highlighted area four map tiles will be needed (outlined in FIG. 13). So four calls from the client to the server are needed asking for data. In this case no data was available previously so the client will not supply any coarser tile identities in the calls. The four calls will in all return three map tiles, one with data from layer 3 (1300) and two from layer 1 (1320). Requests to the server include the best tile the client has available that cover the area of the requested tile, at the time the request is made, so the layer 3 (1300) tile will only be returned once from the server.

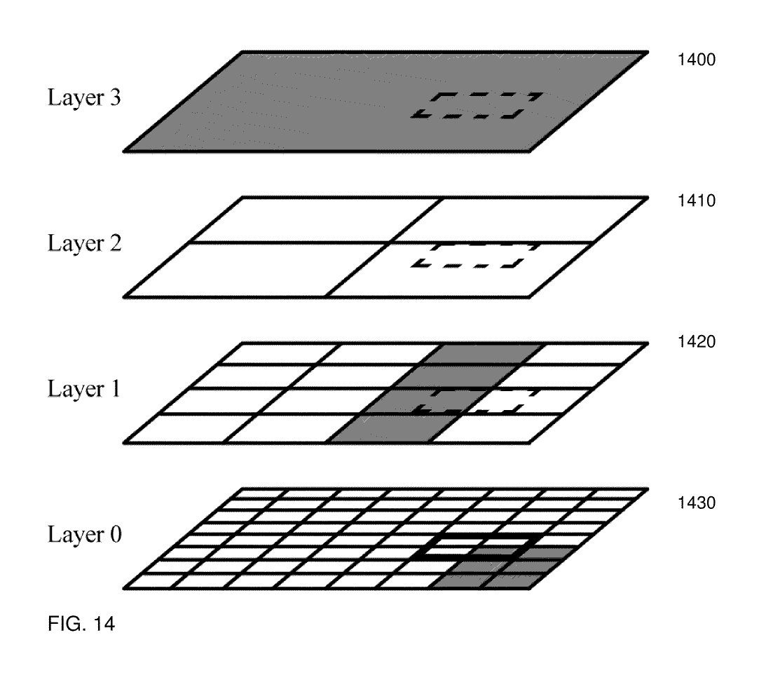

When zooming from layer 1(1420) to layer 0 (1430) in the outlined area in FIG. 14 four tiles are needed to create the map. But now there is data available on the client so when asking for the new map tiles the client adds information on the coarser tile ids covering the same area as the four tiles on layer 0 (1430). The server now only needs to return one new map tile, for the other three no data needs to be returned.

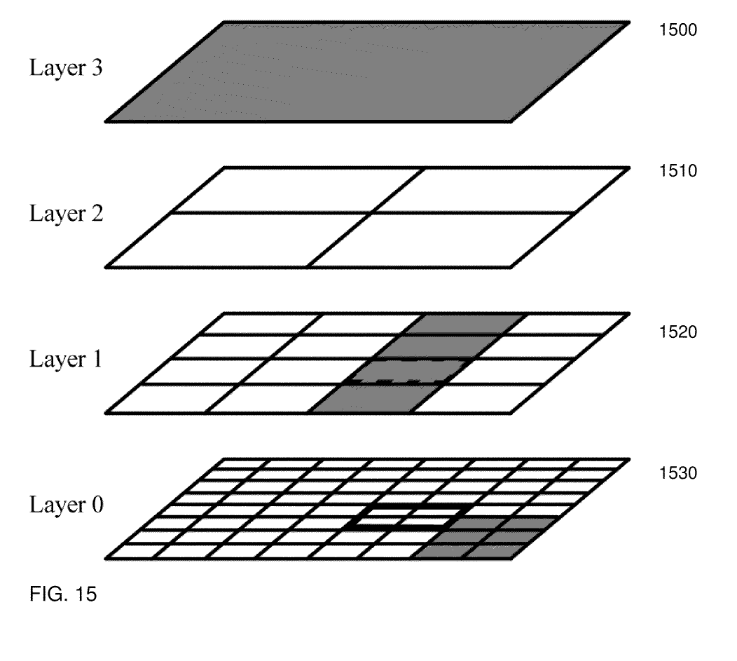

If after that panning the width of one map tile to the left (to the outlined area in FIG. 15) on layer 0 (1530) will return no new data at all, all tiles needed for that map is already in place in the client, in this case from one single tile on layer 1 (1520).

When adding information from different datasets, typically displayed as layers in the application, the gain can be even bigger.

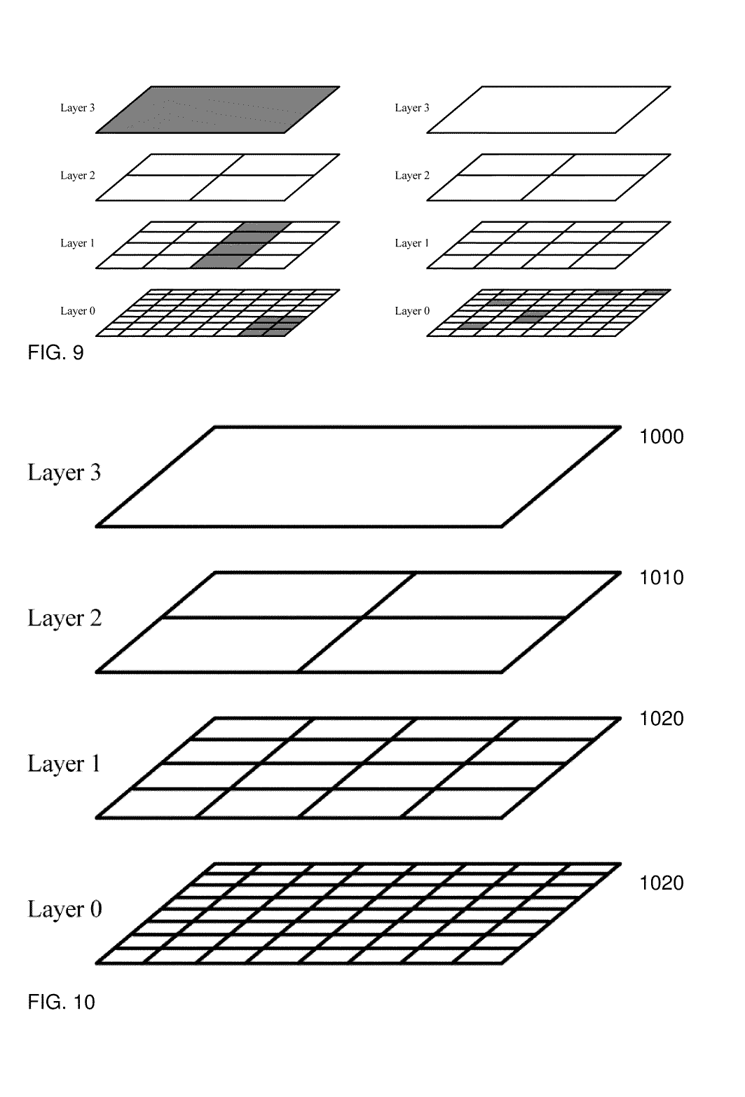

In FIG. 9, data from a different dataset is added to the solution. In a typical setup the left dataset contains standard background map information like terrain, borders, cities etc. and the one on the right contains added information such as landmarks.

The same algorithm will be repeated for tiles in each layer, the difference being that when there are data tiles available from more than one data layer the resulting map tile will be produced by merging the data in the data tiles. Now we have reduced the total map data tiles in several complete trees where each tree is optimized (as described above) individually.

The description in this section is general and as such not dependent on whether data is available as raster images or as vector data. Since local scaling is needed to use a coarser level data tile for a finer local map tree tile the end result when using raster images may be degraded in quality so the invention will be best suited for map data in vector formats.

The above descriptions shows mainly examples in 2D maps, but the invention can also be applied to three-dimensional maps often used in vehicle navigators (such maps are sometimes called birds-eye or 2.5D views) and will then have the same advantages as described above.

Preferred embodiments for the invention, but not limited to these, are car, boat or walking navigation software in a mobile device, moving map display that is mounted inside a vehicle that tracks the vehicles position and orientation by rotating and moving a map, a moving map display in a mobile device that tracks the users position, and orientation if the device includes a compass, with a moving map display, a desktop application for regional rescue services that displays geographic information for an area that takes so much space it is not practical to install and update the geographic data on all clients, battle management software that displays tactical information on a device with limited processing power and/or network connectivity.

### EXAMPLE 1

### A Navigator with Preinstalled Local Data with Data Updates Over Phone Network

One preferred embodiment is car navigation software in dedicated navigator hardware such as Dash Express, by Dash Navigation Inc, Sunnyvale, Calif., USA. Preinstalled on delivery is a fixed set of data covering typically a smaller part of the world. The device can be preloaded with data for an area that is used a lot, for example home city or the country in which it is purchased, which it combines with data downloaded from a network service when inside an area not covered by the locally stored data. The navigator can then connect to a remote server over the mobile phone network. This extra data either be downloaded in a batch transaction, where the invention herein will decrease data transfer time from the now larger local data to internal memory, or fetched over the network on an online, by-need basis, where the invention herein will decrease overall data transfer time both from local storage as above but also from remote storage over the mobile phone network.

### EXAMPLE 2

### A Mobile Phone Using Local and Remote Storage without Preinstalled Data

A mobile phone such as the Nokia N95 using the Symbian OS has local storage but is a more general purpose hardware than the Navigator in Example 1. So a map application does not have any locally stored data when the map application is installed. Geographic data will the be added over mobile phone network similarly to the way described in Example 1 from services accessible via mobile phone network and/or the public Internet. Our invention will enhance data transfer from both local storage and the remote data services.

### EXAMPLE 3

### A Web Application with No Local Storage

Web application does typically not have any local storage so all data has to be loaded from a server. On an lightweight web application accessed by the Microsoft Internet Explorer web browser using the AJAX (Asynchronous Javascript and XML) technique data will be fetched based on current geographic center and scale of the map over the public Internet from a Unix http-server. Panning and zooming will using this invention reduce the number of data transfers over the Internet compared to prior art.

### EXAMPLE 4

### Desktop Application with Locally Installed and Remote Network Disk Data

Another preferred embodiment is a desktop application having local and remote data such as a Windows XP based national rescue services with a .NET Framework 3.5 application displaying geographic information for an area that takes so much space it is not practical to install and update on all clients. The data is stored both on local hard disk installed using standard Windows installation packages and on a remote network disk on a Microsoft Windows Server 2008 accessed through a LAN or WLAN network. The decreased data transfer and processing enabled by the disclosure will significantly enhance the experienced loading time for the maps.

### EXAMPLE 5

### Moving Map in a Army Vehicle without Network Connection

Another preferred embodiment is a moving map display that is mounted inside a military battle vehicle that tracks the vehicles position and orientation by rotating and moving a map. There is no network connection suited for transferring geographic data so all data is preinstalled locally. A separate, standard GPS receiver Globalsat BU-353 is attached via an USB connection on the map hardware. The GPS receiver is used to get the current position of the vehicle and to calculate the direction of the vehicle. Before rendering the map the map is rotated according to the direction and the map is constantly updated to keep the vehicle in center of the rendered map. The decreased time for loading maps enabled by the invention will allow increased accuracy for the critical and quick decisions demanded in a battle situation.

### EXAMPLE 6

### A Tracking Map in a Mobile Phone

Another preferred embodiment is a map display in a mobile phone such as the Nokia 5800 XpressMusic which has a built in or Bluetooth connected GPS receiver. The map application tracks the owner's position with a tracking map display always keeping the center of the map at the current user position. The user position is used for the data fetch as described in the examples above.

The invention can therefore drastically increase the user experienced speed of a map application compared to the solutions of prior art.

The invention introduces at least the following novelties which are not disclosed in the prior art:

generation of complete tiled client maps from incomplete sets of tiled vector data stored locally, remotely on a server, or both;

dynamic packing of data higher in the tile-tree when the density is low, thereby significantly lowering the total number of tiles in the tree without loss of details;

use by a server of information supplied by the client and the structure of the data to return only actual new map tiles needed by the client; and

including information about the neighborhood of a requested tile in a response, thereby enabling the client to decrease the number of requests necessary to generate a complete rendered map image.

The map-loading time reduction will be especially large when pan and zoom operations are the main transitions from one rendered map to the next map.

It will be appreciated that procedures described above are carried out repetitively as necessary. To facilitate understanding, many aspects of this invention are described in terms of sequences of actions that can be performed by, for example, elements of a programmable computer system. It will be recognized that various actions could be performed by specialized circuits (e.g., discrete logic gates interconnected to perform a specialized function or application-specific integrated circuits), by program instructions executed by one or more processors, or by a combination of both.

Moreover, this invention can additionally be considered to be embodied entirely within any form of computer-readable storage medium having stored therein an appropriate set of instructions for use by or in connection with an instruction-execution system, apparatus, or device, such as a computer-based system, processor-containing system, or other system that can fetch instructions from a medium and execute the instructions. As used here, a “computer-readable medium” can be any means that can contain, store, or transport the program for use by or in connection with the instruction-execution system, apparatus, or device. The computer-readable medium can be, for example but not limited to, an electronic, magnetic, optical, electromagnetic, or semiconductor system, apparatus, or device. More specific examples (a non-exhaustive list) of the computer-readable medium include an electrical connection having one or more wires, a portable computer diskette, a random-access memory (RAM), a read-only memory (ROM), an erasable programmable read-only memory (EPROM or Flash memory), and an optical fiber.

Thus, the invention may be embodied in many different forms, not all of which are described above, and all such forms are contemplated to be within the scope of the invention. For each of the various aspects of the invention, any such form may be referred to as “logic configured to” perform a described action, or alternatively as “logic that” performs a described action.

It is emphasized that the terms “comprises” and “comprising”, when used in this application, specify the presence of stated features, integers, steps, or components and do not preclude the presence or addition of one or more other features, integers, steps, components, or groups thereof.

The particular embodiments described above are merely illustrative and should not be considered restrictive in any way. The scope of the invention is determined by the following claims, and all variations and equivalents that fall within the range of the claims are intended to be embraced therein.

What is claimed is:

1. A method of organizing computer-based map data corresponding to an area, comprising:
generating a tile-tree having a plurality of levels of tiles of the map data, wherein tiles of different levels include map data of different respective scales and tiles include respective unique identifiers; and
packing tiles of the tile-tree based on a density of map data to reduce a number of tiles in the tile-tree.

2. The method of claim 1, wherein generating the tile-tree comprises determining a first set of tiles of map data that cover the area at any scale, the first set of tiles being included in any level of the tile-tree, and determining successive sets of tiles included in adjacent levels of the tile-tree from the first set of tiles.

3. The method of claim 1, wherein generating the tile-tree comprises determining a first set of tiles of map data that cover the area at a largest scale, the first set of tiles being included in a first level of the tile-tree, and determining successive sets of tiles included in successive levels of the tile-tree from the first set of tiles

4. The method of claim 1, wherein based on the descriptions, the set of map features is certain to be included in the tiles.

5. The method of claim 1, wherein generating the tile-tree includes generalizing map data of at least one first scale to at least one second scale

6. The method of claim 5, wherein generalizing map data includes removing a feature in the map data of the first scale.

7. The method of claim 5, wherein generalizing map data includes at least one of line-thinning and polygon-thinning the map data of the first scale.

8. The method of claim 1, wherein each tile includes a respective list of detail levels.

9. The method of claim 1, wherein generating the tile-tree includes comparing a size of a tile to a maximum size and splitting the tile into separate tiles if the tile's size exceeds the maximum size.

10. The method of claim 9, wherein the maximum size corresponds to an average size of tiles of a selected group of map data.

11. The method of claim 1, wherein tiles further include descriptions of levels for which at least one set of map features is included in the respective tiles.

12. A method of using computer-based map data, comprising:
receiving a first request for computer-based map data corresponding to an area;
organizing computer-based map data corresponding to the first request according to the method of claim 1; and
sending a response to the first request that includes only at least one tile not previously included in a response to a request corresponding to the first request.

13. The method of claim 12, wherein the response includes information about a neighborhood of a requested tile, and the information decreases a number of requests needed for sending responses that collectively include tiles sufficient for a complete map of the area.

14. The method of claim 13, wherein the request includes an operator on the map of the area, and the operator is a pan or a zoom.

15. An apparatus for organizing computer-based map data corresponding to an area, comprising:
a tile-tree generator configured to generate a tile-tree having a plurality of levels of tiles of the map data, wherein tiles of different levels include map data of different respective scales and tiles include respective unique identifiers; and
a tile packer configured to pack tiles of levels of the tile-tree based on a density of map data to reduce a number of tiles in the tile-tree.

16. A computer-readable medium having stored therein instructions that, when executed by a computer, cause the computer to carry out a method of organizing computer-based map data corresponding to an area, wherein the method comprises:
generating a tile-tree having a plurality of levels of tiles of the map data, wherein tiles of different levels include map data of different respective scales and tiles include respective unique identifiers; and
packing tiles of the tile-tree based on a density of map data to reduce a number of tiles in the tile-tree.
